(19) United States
(12) Patent Application Publication
(10) Pub. No.: US 2024/0372342 A1
(43) Pub. Date: Nov. 7, 2024

(54) Apparatus and Method for Cleaning Multiple High Power Transmission Lines

(71) Applicants: Josh Shachar, Santa Monica, CA (US); Martin Ellenbogen, Ramat Ha Sharon (IL)

(72) Inventors: Josh Shachar, Santa Monica, CA (US); Martin Ellenbogen, Ramat Ha Sharon (IL)

(21) Appl. No.: 18/311,657

(22) Filed: May 3, 2023

(51) Int. Cl. H02G 1/02; B08B 1/00; B08B 1/04; B08B 11/02

(52) U.S. Cl. CPC H02G 1/02; B08B 1/12; B08B 1/30; B08B 1/32; B08B 11/02

(57) ABSTRACT

An apparatus for autonomous cleaning of an electrical wire includes an inductive means to derive power from the electrical wire through inductive coupling, a drive motor for driving motion wheels in contact with the electrical wire, and at least one retractable arm having a cleaning unit comprising a brush in contact with the electrical wire for cleaning the electrical wire. The apparatus is configured to raise the at least one retractable arm when an obstruction on the wire is detected, thereby permitting the apparatus to traverse over the obstruction and continue cleaning the electrical wire. The apparatus also includes a support wheel configured to automatically compensate for any changes in diameter of the wire during the cleaning process. The apparatus may also be used to clean multiple wires at once and is further provided with a suite of electronics for collecting and sending data to an outside operator.

### BACKGROUND

### Field of the Technology

The invention relates to the field of methods or apparatuses specially adapted for installing, maintaining, repairing, or dismantling electric cables or lines, specifically cleaning multiple power lines by methods involving the use of tools, brushes, or analogous members using rotary operative members.

### Description of the Prior Art

Overhead power lines are used to carry current across great distances and interconnect the electric grid between major cities, power stations and remote towns. These lines typically are made from aluminum alloys and carry currents upwards of 1000 kV. Typically, overhead power lines are not insulated to reduce the operational cost of power transmission for large quantities of electric energy. Instead, overhead powerlines are instead insulated by free air. Although aluminum naturally creates a protective oxidized layer, this layer can grow increasingly thick, or there can be a buildup of particles such as airborne salt, ash, minerals deposited by rain, and bird droppings. As material adheres to the power line, the impedance of the line increases and results in power being dissipated from the lines in the form of heat.

The U.S. Energy Information Administration (EIA) estimates that roughly 5% of all electricity entering overhead power lines is lost as a result transmission. The global average is roughly 10%, but in countries such with power lines in states of disrepair, such as India, power losses can exceed 25%. These power losses translate to about 70 TJ of dissipated energy every year for the US alone. The annual dissipated energy is valued at around 2 billion dollars.

To keep sediment from perpetually accumulating on the overhead power lines, utility companies have addressed this issue and regularly clean these power lines of any build ups. There are several problems that arise from the need to regularly scrub power lines. Ground based transmission line cleaning is either dangerous or expensive. If the lines are left live during cleaning, the cleaning crew is exposed to the danger of arcing between the ground and the transmission lines, resulting in short circuits and fatalities. If the lines are disconnected for cleaning, the utility companies looses revenue in the form of lost power sales. Additionally, many transmission lines are inaccessible by ground crews due to the topography through which they run. Many transmission lines run through mountains, dense forests, and in generally remote hard to access areas.

U.S. Pat. No. 10,680,419 APPARATUS AND METHOD FOR CLEANING HIGH POWER TRANSMISSION LINES discloses a device for autonomous cleaning of electrical lines, the device comprising an inductive coil for deriving power from the electrical line. The device comprises wheels for traversing the electrical line and an internal logic circuit which is configured to instruct the device to reverse its direction of travel when an end of the electrical line or other large obstruction is detected. The device further comprises brushes which are powered by the inductive coupling of the device which clean the electrical wire as the device traverses along its length.

U.S. Pat. No. 4,477,289 METHOD FOR WASHING VOLTAGE TRANSMISSION LINE INSULATORS outlines a method for using pressurized water cannons shot from helicopters that addresses the issues of remote access. Helicopter assisted washing addresses the issues ground crews face, but is still costly as it requires specialized labor and the use of helicopters specialty helicopters that have been fitted with the equipment necessary.

Chinese Application CN201620110090 discloses an automatic solar powered cleaning device of transmission lines, which rides on the transmission line and cleans the line unattended using a plurality of motor driven brushes to scrape or brush the line clean around its entire circumference.

What is needed however is an autonomous apparatus for cleaning high power transmission lines which is capable of traversing or moving over spacers or other hot spots that are detected along the line. The apparatus should be capable of collecting data and for monitoring and tracking its position relative to a path of operation determined by a remote operator. The apparatus should also be capable of being configured for cleaning and traversing across multiple adjacent electrical lines at the same time.

### BRIEF SUMMARY

The current invention provides an apparatus for autonomous cleaning of an electrical wire. The apparatus includes a command and control unit, a plurality of retractable arms coupled to the command and control unit, and a cleaning unit disposed on a distal end of each of the plurality of retractable arms. The apparatus also includes at least one motion wheel coupled to a motor disposed in the command and control unit and a support wheel coupled to the command and control unit, where both the at least one motion wheel and the support wheel are configured to be in continuous contact with the electrical wire and compensate for changes in a diameter of the electrical wire.

In one embodiment, each of the cleaning units comprises a housing, a plurality of proximity sensors disposed on an outside surface of the housing, at least one rotating brush configured to clean the electrical wire disposed within an internal cavity of the housing. Each of the cleaning units also comprises at least one brush motor disposed within the housing and coupled to the at least one brush, wherein the housing comprises a hollow center configured to accommodate the electrical wire therein. In this embodiment, the command and control unit may also comprise a control circuit for controlling the operation of the motor disposed in the command and control unit, the plurality of retractable arms, and the at least one brush motor. In a separate related embodiment, at least one of the plurality of proximity sensors disposed on an outside surface of the housing is configured to detect an obstruction disposed on the electrical wire. In yet another related embodiment, at least one of the plurality of proximity sensors disposed on an outside surface of the housing is configured to detect a change in diameter of the electrical wire.

In another embodiment, each of the plurality of retractable arms are configured to selectively remove the cleaning unit from a surface of the electrical wire.

In a further embodiment, the apparatus further includes a plurality of signal and warning lights that are removably coupled to the command and control unit.

In another embodiment, the support wheel is coupled to a support rod that is disposed through a spring housing which in turn is disposed on the command and control unit. The spring is preferably disposed between an end portion of the support rod and the spring housing.

In one embodiment, the command and control unit includes a plurality of sub units, each of the plurality of sub units in turn including at least one of the plurality of retractable arms.

In a related embodiment, the apparatus also includes at least one extended retractable arm that is coupled to the command and control unit, the at least one extended retractable arm having a cleaning unit disposed on its corresponding distal end.

The invention also provides a system for autonomous cleaning of a plurality of electrical wires. The system includes a first module and a second module in communication with the first module. The first module and the second module each comprise a command and control unit, a plurality of sub units disposed on the command and control unit, and a plurality of retractable arms coupled to each of the plurality of sub units. A cleaning unit is disposed on a distal end of each of the plurality of retractable arms. At least one motion wheel is coupled to a motor disposed in each of the sub units, the at least one motion wheel being in continuous contact with one of the plurality of electrical wires. The first and second modules also each include a support wheel coupled to each of the plurality of sub units, the support wheel being in continuous contact with one of the electrical wire and configured to compensate for changes in a diameter of the electrical wire.

In one embodiment, the support wheel coupled to the command and control unit is coupled to a support rod that is disposed through a spring housing that is in turn disposed on the command and control unit, the support rod being specifically configured to maintain the support wheel at an angle relative to the at least one motion wheel.

In another embodiment, either the first module or the second module is configured to engage a length of at least two of the plurality electrical wires from a position that is above the at least two of the plurality of electrical wires, while the remaining one of the first module or the second module is in turn configured to engage a length of at least two of the plurality electrical wires from a position that is below the at least two of the plurality of electrical wires.

In another embodiment, the first module and the second module are each configured to transmit and receive signals, data, commands, or instructions to each other and to an outsider operator.

The current invention also provides a method for autonomously cleaning an electrical wire. The method includes engaging the electrical wire between a support wheel and at least one motion wheel of a cleaning device, brushing a surface of the electrical wire with a first cleaning unit disposed on a distal end of a first retractable arm that is disposed on the cleaning device, and then detecting an obstruction on the electrical wire by the first cleaning unit. Next, the first cleaning unit is retracted off of the electrical wire so that the cleaning device may traverse over the obstruction detected on the electrical wire. The first cleaning unit then reengages with the electrical wire and resumes brushing of the surface of the electrical wire.

In one embodiment, the method further includes detecting the obstruction on the electrical wire by a second cleaning unit disposed on a distal end of a second retractable arm that disposed on the cleaning device after the cleaning device has traversed over the obstruction on the electrical wire. The second cleaning unit is then retracted off of the electrical wire so that the cleaning device may traverse down a length of the electrical wire. The second cleaning unit then reengages with the electrical wire and resumes brushing of the surface of the electrical wire with the second cleaning unit.

In another embodiment, the step of engaging the electrical wire between the support wheel and the at least one motion wheel of the cleaning device includes the support wheel automatically compensating for a change in diameter of the electrical wire.

In a further embodiment, the method may also include the cleaning device transmitting a data signal related to at least one of an elapsed operation time, a distance traveled by the cleaning device, or a number or type of obstructions detected by the cleaning device to a remote location.

In one embodiment, the method may also include performing data collection, operational monitoring, performing remote control of the first cleaning unit, performing data wireless communication, or visually inspecting the electrical wire with at least one camera to provide real time or recorded visual inspection of the electrical wire and cleaning of the electrical wire.

The current invention further provides a method for autonomously cleaning a plurality of electrical wires. The method includes engaging a first parallel pair of the plurality of electrical wires with a first cleaning device, engaging a second parallel pair of the plurality of electrical wires with a second cleaning device, and transmitting a plurality of data and command signals between the first cleaning device and the second cleaning device. The method further includes brushing a surface of the first parallel pair of the plurality of electrical wires with a first plurality of cleaning units disposed on a respective distal end of a first plurality of retractable arms disposed on the first cleaning device, and brushing a surface of the second parallel pair of the plurality of electrical wires with a second plurality of cleaning units disposed on a respective distal end of a second plurality of retractable arms disposed on the second cleaning device. The step of engaging the first parallel pair of the plurality of electrical wires with the first cleaning device includes engaging the first pair of parallel electrical wires from a position above the first pair of parallel electrical wires, while engaging the second parallel pair of the plurality of electrical wires with the second cleaning device comprises engaging the second pair of parallel electrical wires from a position below the second pair of parallel electrical wires.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a perspective view illustrating an autonomous cleaning device according to the current invention.

FIG. 2A is a side view the cleaning device seen FIG. 1 when the cleaning device is engaged with an electrical wire.

FIG. 2B is a magnified view of the command and control unit portion of the cleaning device seen in FIG. 2A.

FIG. 3A is a partially transparent perspective view of the command and control unit illustrating the internal drive means of the cleaning device.

FIG. 3B is a partially transparent perspective view of the command and control unit seen in FIG. 3A with one side of the chain housing removed to illustrate a horizontal drive chain disposed therein.

FIG. 4 is a magnified cross sectional view of a motion wheel used to move the cleaning device along the electrical wire.

FIG. 5A is a magnified frontal view of the cleaning device illustrating how the support wheel and support rod may be adjusted in order to engage the electrical wire.

FIG. 5B is a magnified frontal view of the cleaning device after the support wheel and support rod have been adjusted in order to engage the electrical wire between the support wheel and a motion wheel.

FIG. 6 is a magnified perspective view of a cleaning unit, each cleaning being disposed on a distal end of a retractable arm disposed on the cleaning device.

FIG. 7A is a partially transparent frontal view of the cleaning unit seen in FIG. 6.

FIG. 7B is a partially transparent rear view of the cleaning unit seen in FIG. 6.

FIG. 8 is a partially transparent frontal view of the cleaning unit, where the cleaning unit has been inverted to accommodate an electrical wire therein.

FIG. 9 is a cross sectional view of the cleaning unit seen in FIG. 8.

FIG. 10A is a side view of the cleaning device as a proximity sensor disposed on a lead cleaning unit detects an obstruction disposed on the electrical wire.

FIG. 10B is a perspective view of the cleaning device as a proximity sensor disposed on a lead cleaning unit detects an obstruction disposed on the electrical wire.

FIG. 11 is a perspective view of the cleaning device after a lead retractable arm has been actuated so as to remove a lead cleaning unit from the surface of the electrical wire.

FIG. 12 is a perspective view of an alternative embodiment of the cleaning device, the cleaning device configured to engage and clean a pair of parallel electrical wires.

FIG. 13 is a perspective view of an alternative embodiment of the cleaning device, the cleaning device configured to engage and clean a pair of parallel electrical wires disposed above a single, lower electrical wire.

FIG. 14A is a side view of the cleaning device seen in FIG. 13 as the proximity sensors disposed on the lead cleaning units detect an obstruction disposed on the electrical wire.

FIG. 14B is a side view of the cleaning device seen in FIG. 14A as the lead cleaning units are lifted off of a surface of the electrical wire.

FIG. 15 is a perspective view of an alternative embodiment of the cleaning device, the cleaning device including an upper module configured to engage and clean a pair of parallel upper electrical wires and a lower module configured to engage and clean a pair of parallel lower electrical wires.

FIG. 16 is a magnified perspective view of the upper module of the cleaning device seen in FIG. 15, illustrating a rear cleaning unit and an angled support wheel.

FIG. 17 is a front cross sectional view of the cleaning device seen in FIG. 15 as a it approaches a spacer coupled to the upper and lower electrical wires.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

The illustrated embodiments of the invention are directed to a device 10 that attaches to electrical transmission lines or wires 12 and serves as an autonomous cleaning mechanism for medium and high voltage transmission wires 12. The device 10 derives its power from the high voltage wires 12 through inductive coupling and uses this power to move a command and control unit 14 in which one or more motors 16 included in the command and control unit 14 and to rotate a plurality of metal or steel brushes 18 or other types of brushes 18 provided with other rigid and durable fibers.

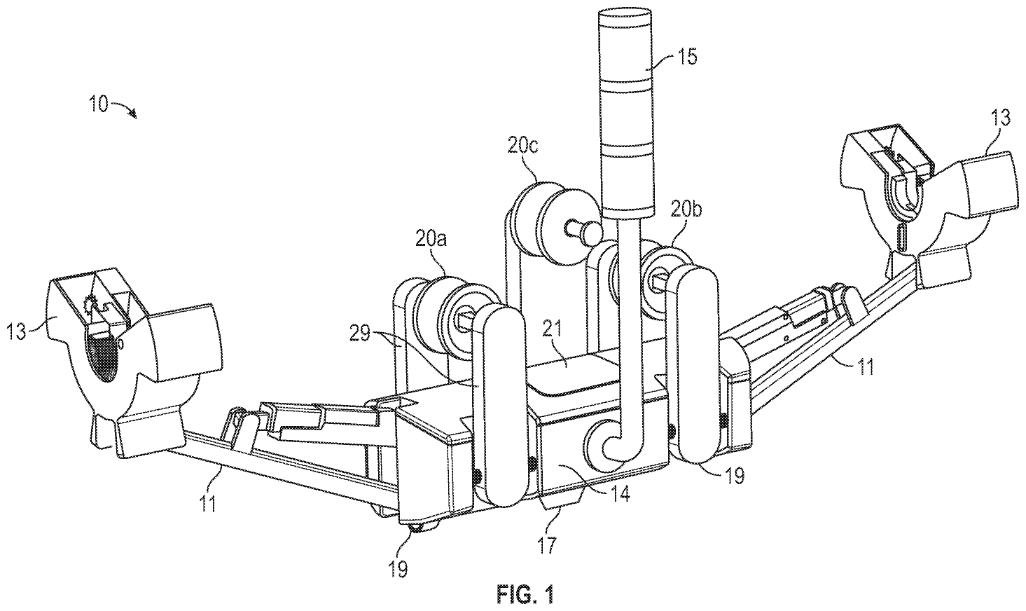

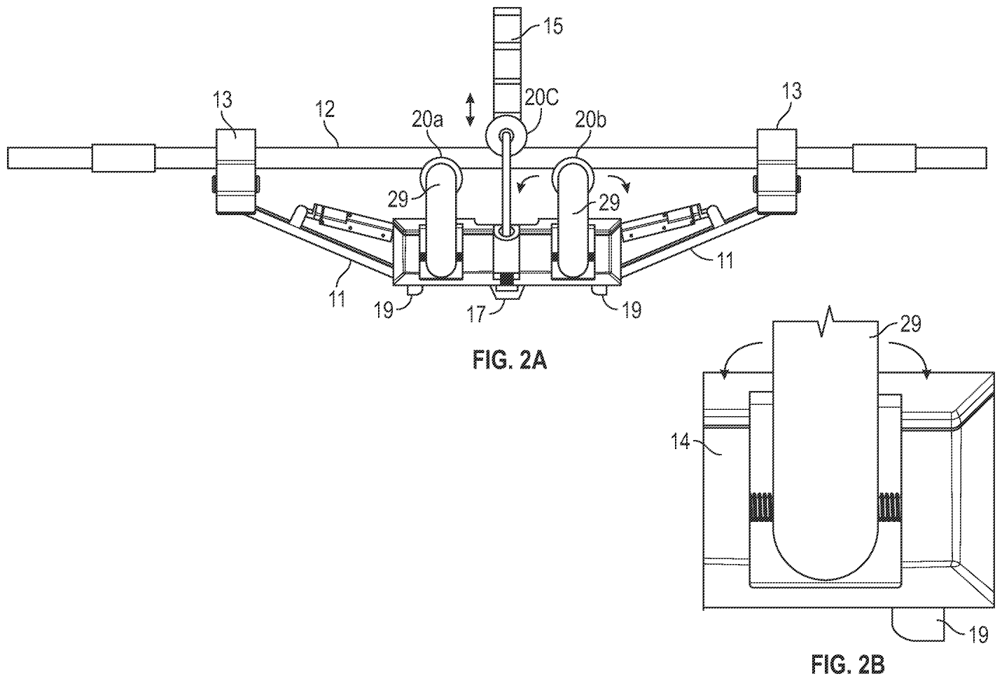

In some embodiments seen in FIGS. 1-2B, the command and control unit 14 comprises a plurality of retractable hydraulically operated arms 11 which extend from either lateral side of the command and control unit 14. Disposed at a distal end of each arm 11 is a cleaning unit 13 which comprises a least one brush 18 and which accommodates a diameter of the wire 12 therein. A plurality of signal and warning lights 15 are removably coupled to the command and control unit 14. In some embodiments, the signal and warning lights 15 comprises one or more LEDs and is configured to give visual warning to aircraft or other entities of the physical presence of both the device 10 and the wire 12 on which the device 10 is currently engaged. The signal and warning lights 15 are connected to a microcontroller or logic circuit within the command and control unit 14 so that the device 10 may signal to outside observers or operators the current status or operational state of the device 10. For example, when the device 10 is in the operational mode and traversing along the wire 12, the microcontroller or logic circuit may command the signal or warnings lights 15 to illuminate a green LED disposed therein to signal that the device 10 is currently in use. In other embodiments, other colors, sequences, or patterns of LEDs may be used to denote any number of functions of the device 10 including but not limited to when the device 10 is offline or malfunctioning, when the device 10 is currently traversing a hot spot or other obstruction as detailed below, or when the device is in a standby mode, among many others. In certain embodiments, the command and control unit 14 also comprises a communications antenna 17 and a pair of IR cameras 19, one IR camera 19 being disposed at each lateral end of the command and control unit 14. An electromagnetic sensor 21 is also coupled to or is disposed within the command and control unit 14 in some embodiments.

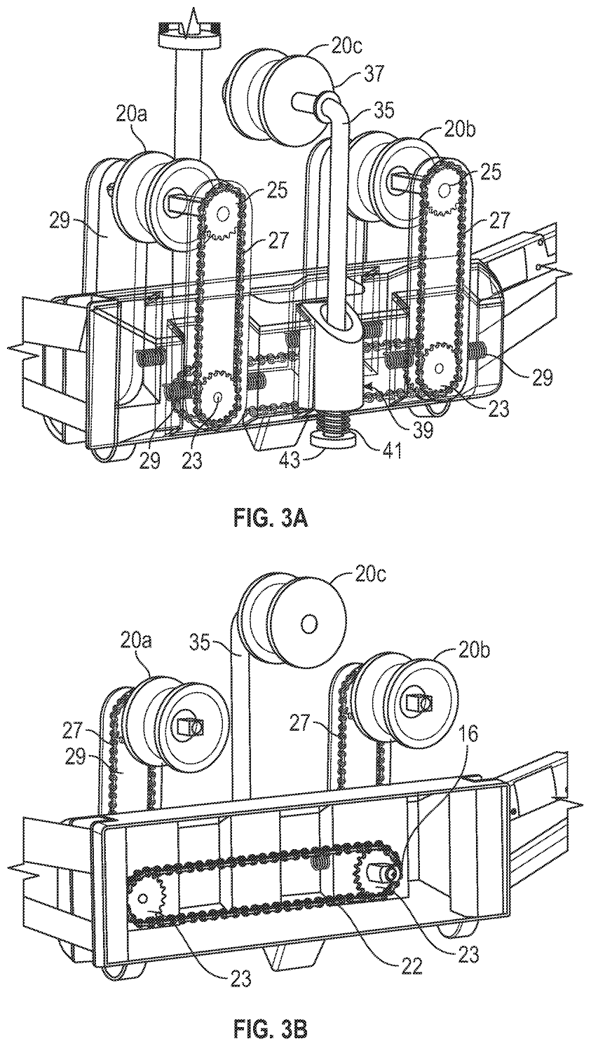

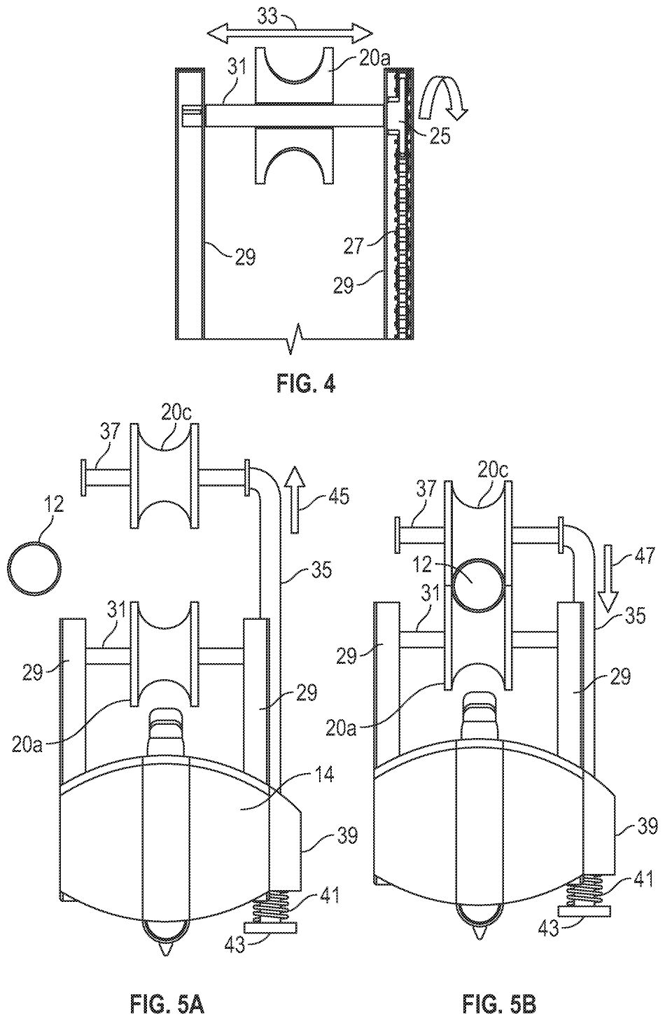

In some embodiments, the command and control unit 14 seen in FIGS. 3A and 3B rides on a pair of motion wheels 20a and 20b and a support wheel 20c between which line 12 is engaged or held. In some embodiments, the motion wheels 20a, 20b and the support wheel 20c engage the wire 12 from below and from above, respectively. The motor 16 disposed within the command and control unit 14 is coupled to and rotates the motion wheels 20a, 20b via a horizontal oriented drive chain 22 as best seen in FIG. 3B, the motion wheels 20a, 20b riding on the bottom of line 12 to translate the command and control unit 14 along the line 12. In one embodiment, the motor 16 rotates the drive chain 22 which in turn rotates a plurality of first gears 23, each of the plurality of first gears 23 being disposed in a lower portion of a corresponding chain housing 29. Each of the plurality of first gears 23 are also coupled to a corresponding one of a plurality of vertically oriented wheel chains 27 which are each in turn coupled to a corresponding one of a plurality of second gears 25 at their respective opposing ends. In some embodiments, each of the plurality of chain housings 29 comprises at least one of the plurality of first gears 23 at a lower portion of the chain housing 29, one of the plurality of second gears 25 at an upper portion of the chain housing 29, and a wheel chain 27 disposed and engaged therebetween. In at least one embodiment, the plurality of chain housings 29 are disposed symmetrically about the command and control unit 14, namely with at least two chain housings 29 disposed on each longitudinal surface of the command and control unit 14, and with at least two chain housings 29 disposed on either side of each of the motion wheels 20a, 20b. Turning to FIG. 4, an axle 31 is disposed between the second gears 25 of two adjacent chain housings 29, the axle 31 being disposed through a center of the corresponding motion wheel 20a, 20b. In one embodiment, the axle 31 comprises a substantially square shaped cross section which allows for the motion wheel 20a, 20b to move along the length of the axle 31 in the directions shown by arrow 33, thereby permitting the motion wheels 20a, 20b to be adjusted for varying distances between adjacent wires 12.

Returning to FIG. 3A, the support wheel 20c is seen coupled to an axle 37 which in turn is coupled to an adjustable support rod 35. The support rod 35 is substantially vertically oriented and is coupled to the command and control 14 via a spring housing 39. A spring 41 disposed between the spring housing 39 and a fixed end portion 43 of the support rod 35 allows the support rod 35 to automatically adjust to a change in diameter of the wire 12 as the device 10 is traversing across its length. For example, if the diameter of the wire 12 on which the device 10 is engaged increases, the support wheel 20c and the motion wheels 20a, 20b are pushed further apart in the vertical direction, thereby moving the support rod 35 upward relative to the command and control unit 14 and compressing the spring 41. The positive pressure applied by the spring 41 ensures that the support wheel 20c and the motion wheels 20a, 20b remain securely engaged with the wire 12 during use of the device 10. Should the diameter of the wire 12 decrease, the support wheel 20c automatically moves vertically downward toward the motion wheels 20a, 20b which at the same time moves the support rod 35 downward and relaxes the spring 41 by a corresponding amount.

Further detail of how the support rod 35 and spring 41 may be used to engage the device 10 with a wire 12 may be seen in FIGS. 5A and 5B. In some embodiments, the device 10 may be disposed onto a wire 12 by first moving or pulling the support rod 35 in the upward direction indicated by arrow 45. The upward movement of the support rod 35 brings the end portion 43 up towards the spring housing 39, thereby compressing the spring 41 disposed therebetween. The device 10 is then moved toward the wire 12, with the cross section of the wire 12 fitting between the upward facing portions of the motion wheels 20a, 20b and the downward facing portion of the support wheel 20c. In one embodiment, the support rod 35 may be released which allows the spring 41 to expand and quickly bring the support wheel 20c and the motion wheels 20a, 20b into direct contact with upper and lower sides of the wire 12, respectively.

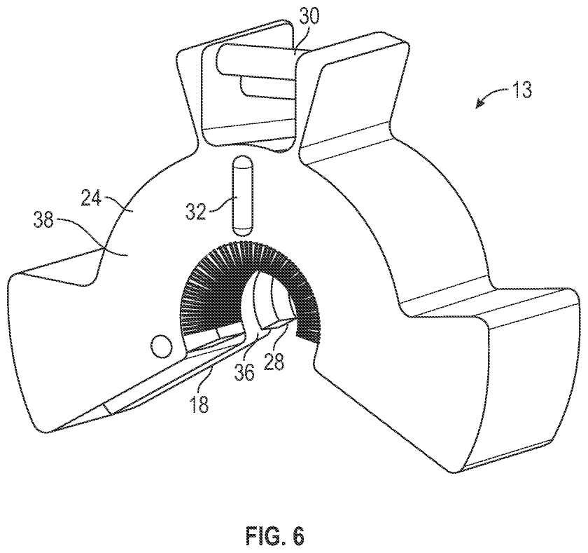

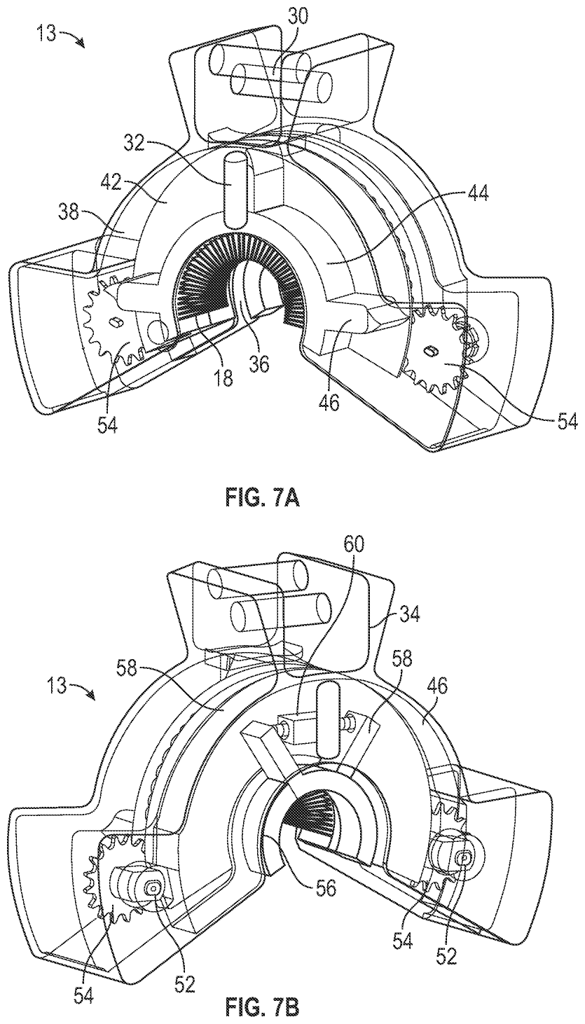

Greater detail of the cleaning unit 13 may be had by turning to FIGS. 6-9. In some embodiments, each cleaning unit 13 comprises a housing 24 which is substantially “U” or “C” shaped, namely with a curved portion or surface with an opening or void defined over at least one arc segment of the housing 24. The housing 24 comprises a front surface 38 and a back surface 40 joined together by an inner cavity 36. The housing 24 further comprises a hollow center 28 which is substantially circular shaped so as to accommodate the diameter of the wire 12. The housing 24 also comprises a coupling portion 30 that is configured to interact or engage with a distal end of one of the plurality of arms 11. For example, in certain embodiments the coupling portion 30 is configured to automatically adjust the position of the cleaning unit 13 relative to the arm 11 so as to accommodate the distance between adjacent or subsequent wires 12. Disposed within the hollow center 28 is a brush 18 that is disposed over a portion of the inner cavity 36 of the housing 24 that defines the hollow center 28. In one embodiment, the brush 18 is disposed within the inner cavity 36 at a position that is adjacent or in close proximity to the front surface 38 of the housing 24 as best seen in FIGS. 6 and 7A. In some embodiments, a first or front proximity sensor 32 is disposed on a first or front surface of the housing 24, while a second or back proximity sensor 34 is disposed on a corresponding second or back surface of the housing 24.

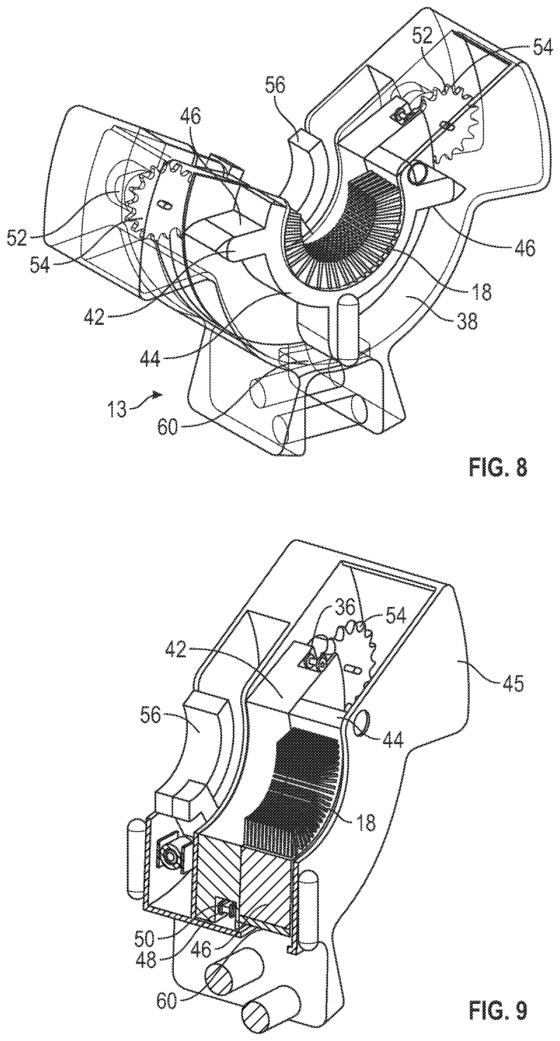

Turning to the partially transparent views of FIGS. 7A, 7B, and 8, each cleaning unit 13 comprises a brush plate 42 onto which an elastomeric or rubber “C” ring 44 is coupled. Both the brush plate 42 and the “C” ring 44 comprise the same substantially “U” or “C” shaped cross section of the housing 24. The “C” ring 44 comprises a plurality of wipers 46 symmetrically disposed over an arc length of the “C” ring 44, each one of the plurality of wipers 46 radially extending from the “C” ring 44. In some embodiments, the brush 18 is coupled to an inside surface of the “C” ring 44 as best seen in FIGS. 7A and 8. As further seen in FIG. 8, the housing 24 of the cleaning unit 13 comprises a draining orifice 60 defined through a bottom portion thereof such that as the “C” ring 44 and its corresponding wipers 46 are rotated through the inner cavity 36, any dirt or other debris picked up by the brush 18 is swept by the wipers 46 towards to the draining orifice 60. The removed dirt and debris are then pushed into the draining orifice 60 and then allowed to fall out of the cleaning unit 13.

Additionally, each cleaning unit 13 also comprises a brake 56, which in one embodiment seen in FIG. 7B is disposed within the inner cavity 36 adjacent to the back surface 40 of the housing 24. The brake 56 comprises a substantially “C” shape or profile and a pair of prongs 58 which extend radially therefrom. An actuator 60 is disposed between the pair of prongs 58, and when activated, the actuator 60 pushes each of the prongs 58 in either lateral direction which in turn causes the brake 56 to contract, bringing the opposing ends of the substantially “C” shape of the brake 56 closer together and squeezing the wire 12 when disposed therein. In this manner, the device 10 may use the brake 56 to slow down or stop when needed as it traversing along the length of the wire 12.

In certain embodiments, each cleaning unit 13 comprises a brush proximity sensor 45 disposed or coupled to the front surface 38 of the housing 45. The brush proximity sensor 45 is communicated to the command and control unit 14 and is configured to detect an unexpected change in the diameter of the wire 12. When a change in diameter is detected, the brush proximity sensor 45 signals the command and control unit 14 which then uses its internal logic circuit to command both the motor 16 to stop forward movement of the device 10 and the brush motors 52 to immediately stop rotation of the brush 18. The command and control unit 14 then commands the motor 16 to reverse orientation so as to back up or return the device 10 to a position along the wire 12 before the change in wire diameter was detected. The command and control unit 14 then signals an outside operator of the change in diameter, and in certain embodiments, awaits further commands therefrom. At this point, the outside user may replace or switch the brush 18 with a larger or smaller brush as necessary in order to compensate for the change in wire diameter. Alternatively, the outside user may instruct the device 10 via remote control to return to its originally starting position along the wire 12, thereby avoiding the change in diameter of the wire 12 completely. By detecting a change in diameter of the wire 12 before the brush 18 makes significant contact with it, the brush proximity sensor 45 ensures that the wire 12 does not inadvertently damage the brush 18 or any other part of the device 10.

In some embodiments, each cleaning unit 13 comprises at least a pair of brush motors 52 disposed within opposing ends of the inner cavity 36 of the housing 24. Each brush motor 52 is coupled to a brush gear 54 which in turn is engaged with a chain 50 that is disposed within a track 48 defined within the brush plate 42. Upon actuation of the brush motors 52, each of the corresponding brush gears 54 are rotated so as to rotate the brush plate 42 via their respective engagement with the chain 50. By extension, the brush 18 coupled to the brush plate 42 is simultaneously rotated. In some embodiments, the brush plate 42 rotates either clockwise or counterclockwise around a center point defined by the hollow center 28 of the housing 24, the brush 18 and brush plate 42 moving in and out of the inner cavity 36 of the housing 24 as the brush gears 54 continue to engage with the chain 50. Because the brush plate 42 comprises a substantially “C” shaped profile, at least one of the pair of brush gears 54 is actively engaged with the chain 50 at all times. In one embodiment, the brush 18 is continuously rotated by the brush motors 52 and brush gears 54 so that the brush 18 constantly rotates about the hollow center 28 for as long as the brush motors 52 are actuated. In this manner, the brush 18 may continuously revolve or rotate around the outer circumference of the wire 12 that the device 10 is actively traversing. In other embodiments, the brush motors 52 are configured to provide intermittent alternating actuation so that the brush 18 may complete a sequence of partial rotations in opposing directions about the wire 12, thereby providing a “scrubbing” or “to-and-fro” motion with respect to the wire 12.

The purpose of the brushes 18 is to clean debris from the high voltage wire 12 on which the device 10 rides as the command and control unit 14 moves from one end of the wire 12 to the other between transmission towers or poles, thereby reducing ohmic losses and heating of the wire 12. In some embodiments, when the device 10 reaches one end of the wire 12, it detects the line termination, such as by a pressure or limit switch as taught and described within U.S. Pat. No. 10,680,419 which is herein incorporated by reference in its entirety. The device 10 stops and automatically reverses direction to move toward the opposite end of the wire 12 from which it just came. This cleaning action can be repeated or continued indefinitely, inasmuch as the device is self-contained and autonomously operated using the cleaned electrical wire 12 as a power source.

A single brush 18 spanning an angular segment of the hollow center 28 of the housing 24 of each cleaning unit 13 is shown in the embodiment of FIGS. 6-9, but any number of brushes 18 may be employed with differing angular spans for each. For example, in some embodiments the brushes 18 may be all aligned on the same circumferential cross section of wire 12, but it is contemplated that in other embodiments the brushes 18 may be longitudinally spaced along wire 12 to provide an overlapping circumferential coverage of the exterior of wire 12. The number and arrangement of brushes 18 contemplated within the scope of the illustrated embodiments are virtually without limitation and innumerable.

The transmission wire 12, when alive, carries a high AC current at high voltage, typically tens to hundreds of thousands of volts with high currents, which results in an AC solenoidal magnetic field generated around each line. Inductance between lines due to this magnetic field and its management is well understood. The electromagnetic sensor 21 of the command and control 14 is configured to induce a current from the magnetic field generated by the current running through the wire 12. This induced current is then used to power motors 16, 52 and a microcontroller or controller logic disposed within the command and control unit 14. Additional detail of how the command and control unit 14 inductively receives AC power from the wire 12 is further shown and described within U.S. Pat. No. 10,680,419, which is incorporated by reference in its entirety as noted above.

The command and control unit 14 on wire 12 includes a power supply section coupled to coil (not seen) for inductively picking up AC power from wire 12. The AC voltage is converted into a DC power signal and supplied to a microcontroller or controller logic and directional switches disposed within the electromagnetic sensor 21. The status of motion and position of command and control unit 14 as determined by the first and second proximity sensors 32, 34 are provided to a logic and latching section within the electromagnetic sensor 21 from which input the directional control of reversible motor 16 is controlled. The operation of the device 10 can be turned on or off as desired by means of remote control of an onboard microcontroller or controller logic from either a ground based signal or a predetermined calendar file, thereby completing and interrupting the electrical motor 16.

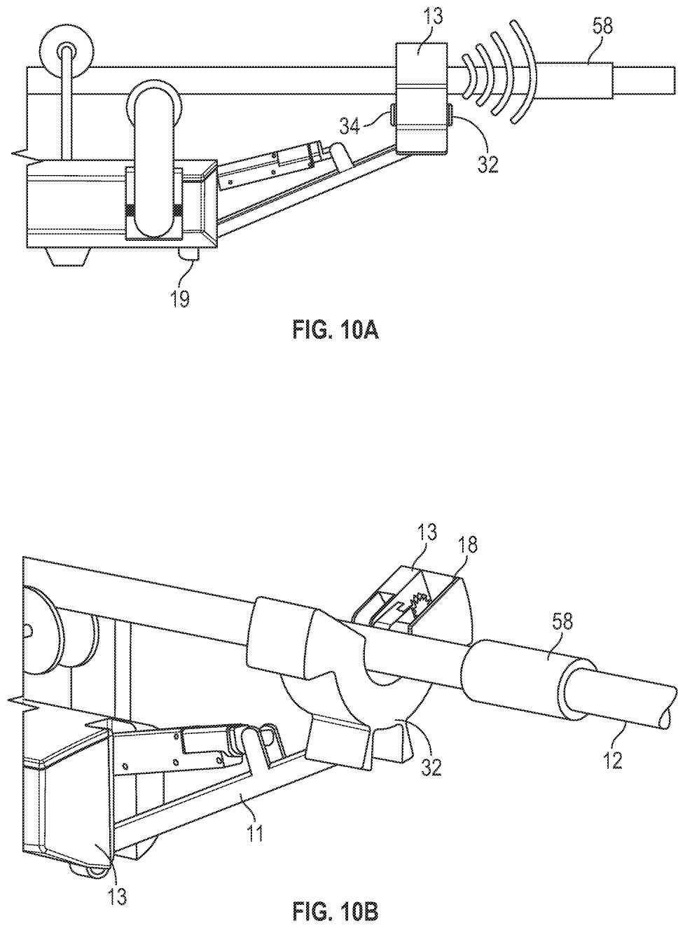

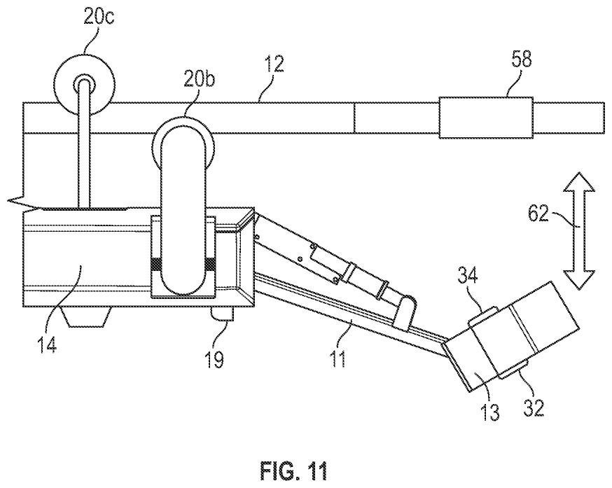

In some embodiments, each of the first and second proximity sensors 32, 34 determine not only the direction of motion of the command and control unit 14 on the wire 12, but also the presence of any obstructions on the wire 12 including but not limited to hot spots, spacers, or any other abnormality which may change the diameter of the wire 12. In one example, when the device 10 approaches a hot spot 58 disposed on the wire 12 as seen in FIGS. 10A and 10B, the first proximity sensor 32 disposed on a lead cleaning unit 13 detects the position of the hot spot 58 and notifies the command and control unit 14 of its presence. In some embodiments, an operational user may also be notified of the presence of the hot spot 58. The internal logic of the command and control unit 14 automatically follows a predetermined sequence of motions to traverse over the hot spot 58 without user interaction or intervention. For example, after coming to a stop using the brakes 56, the command and control unit 14 retracts or raises the lead cleaning unit 13 off of the wire 12 by actuating the corresponding hydraulic arm 11 in direction denoted by arrow 62 seen in FIG. 11. The command and control unit 14 then actuates the motor 16 to drive motion wheels 20a, 20b so that the command and control unit 14 moves forward towards the hot spot 58 with the lead cleaning unit 13 remaining in a raised or retracted position from the wire 12. As the first motion wheel 20b makes contact with the hot spot 58, the increased diameter of the hot spot 58 relative to the wire 12 is compensated by the support rod 35 moving upward which in turn further compresses the spring 41, thereby ensuring that both the motion wheel 20b and the support wheel 20c remain firmly engaged with hot spot 58 and the wire 12, respectively. After the retracted cleaning unit 13 has moved past the hot spot 58, the command and control unit 14 reengages the lead cleaning unit 13 by actuating the arm 11 so as to bring the cleaning unit 13 towards the wire 12, the brush 18 once again making contact with the wire 12. The second proximity sensor 34 disposed on the lead cleaning unit 13 ensures that the hot spot 58 is now in fact behind or downstream of the lead cleaning unit 13. The command and control unit 14 resumes its traversal down the wire 12 in the same original direction until the first proximity sensor 32 disposed on the remaining or rear cleaning unit 13 detects the hot spot 58. The command and control unit 14 then actuates the arm 11 coupled to the rear cleaning unit 13 which retracts or pulls the rear cleaning unit 13 off of the surface of the wire 12. Next the command and control unit 14 once again moves forward with the support wheel 20c and the remaining motion wheel 20a compensating for the larger relative diameter of the hot spot 58 as the device full traverses over the length of the hot spot 58. After passing the hot spot 58, the command and control unit 14 actuates the arm 11, thereby bringing the rear the cleaning unit 13 back into contact with the wire 12. The second proximity sensor 34 disposed on the cleaning unit 13 confirms the position of the rear cleaning unit 13 along the length of the wire 12 relative to the position of the hot spot 58. Once fully clear of the hot spot 58, the command and control unit 14 once again signals the motor 16 to drive the device 10 forward along the length of the wire 12 with each of the brushes 18 disposed within the corresponding cleaning units 13 brushing or scrubbing the wire 12 while the device 10 is in transit. It is in this manner of first raising a “lead” cleaning unit 13, moving over the obstruction, lowering the “lead” cleaning unit, and then repeating the process with a “rear” cleaning unit 13, that the device 10 can “walk” or “step over” the hot spot 58 in its path so as to continue perform its principal task of cleaning the length of the wire 12.

It is important to distinguish that the “first” and “second” proximity sensors 32, 34 as well as the “lead” and “rear” cleaning units 13 as described above are meant for illustrative purposes only and that what may be considered or defined as the “first” or “second” as well as the “lead” or “rear” is a relative designation. For example, if the device 10 is traversing across a wire 12 in a first direction and then reaches an end of the wire 12 where it then reverses its motion of travel and proceeds in a second direction, what was originally considered the “first” or “lead” as the device 10 travels in the first direction will necessarily be switched or swapped with the designation of “second” or “rear” when the device 10 reverses itself and travels in the second direction. Additionally, it should be emphasized that while a hot spot 58 was used in the description above, the device 10 may avoid or traverse across any other object including spacers or the like in the same manner, namely by retracting a first cleaning unit 13, moving the retracted first cleaning unit 13 past the obstruction, reengaging the first cleaning unit 13 with the wire 12, retracting a second cleaning unit 13, moving the retracted second cleaning unit 13 past the obstruction, and then reengaging the second cleaning unit 13 with the wire 12.

In addition to the operational circuitry used by the device 10 and disposed within the command and control unit 14, in some embodiments there is additional circuitry and sensors which may not be principally used for the movement of command and control unit 14. Such circuitry and sensors may involve, in some embodiments, data collection and data reporting sensors. For example, the device 10 comprises an internal clock or other means for monitoring and recording elapsed operation time, an odometer to measure distance traveled by the device 10, the number or type of obstructions detected along a particular length of the wire 12, and any other operational metric which may be useful or beneficial to the remote operator or user of the device 10. In certain embodiments, the device 10 further comprises various monitoring functions for various operations such as real time positional awareness through a GPS unit or the real time monitoring of the wire 12 which the device 10 is currently cleaning through one or more infrared (IR) cameras 19 that are disposed on the command and control unit 14 may also be included. Additionally, the command and control unit 14 further comprises an antenna 17 which allows it to be remotely controlled via a radio frequency (RF) link. The antenna 17 further provides for the transmission of any data collected or recorded by the device 10 to a remote location via the means of a RF transmission, BlueTooth®, or any other means of transmission. In certain embodiments, any type of outgoing and incoming signals such as remotely transmitted instructions or changes to the operational procedures of the device 10 are transmitted and received through the antenna 17 disposed on the command and control unit 14.

In some embodiments, the command and control unit 14 comprises an internal microcontroller or controller logic for managing each of the various functions of the device. As used herein, microcontroller or controller logic is broadly understood to include any secondary electronic equipment desired. For example, an RF digital transceiver may be included and coupled to microcontroller or controller logic for communication with a remote station or control center using any one of a plurality of possible networks or communication links for remote reporting and control to and from device 10. Still further, the device 10 may include on or more inspection cameras that provide real time or recorded visual inspection of wire 12 and the state of its cleanliness or other condition.

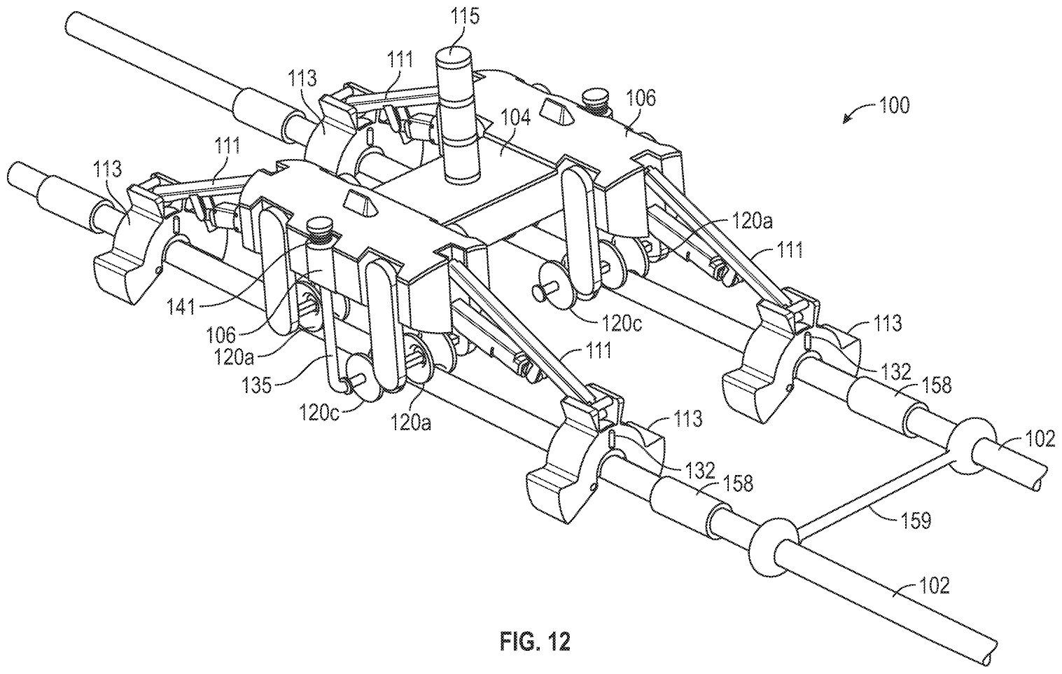

An alternative embodiment of the power line cleaning device 100 may be seen in FIG. 12 where the device 100 is specifically configured to engage, traverse, and clean a pair of parallel wires 102. In this embodiment, a command and control unit 104 of the device 100 extends between substantially similar sub-units 106, each one of the sub-units 106 being disposed on one of the pair of parallel wires 102. The device 100 traverses the wires 102 from a top portion or surface of the wires 102, namely with the command and control unit 104 and sub-units 106 being disposed above the wires 102 while the cleaning units 113 of each of the sub-units 106 extend downward from the device 100 to engage with the respective wires 102. In some embodiments, a signal and warning light 115 is disposed on the command and control unit 104 and between the parallel wires 102.

Each of the sub-units 106 are substantially similar to the power line cleaning device 10 disclosed above, namely with each sub-unit 106 comprising a pair of motion wheels 120a, 120b which are driven by a motor (not seen) disposed within the sub-unit 106. Each sub-unit 106 also comprises a support wheel 120c coupled to the sub-unit 106 by a support rod 135 and a spring 141. Because each sub-unit 106 comprises its own support wheel 120c and support rod 135, each sub-unit 106 may independently and automatically adjust or compensate for a change in diameter of the wire 102 onto which the sub-unit 106 is currently disposed. Each sub-unit 106 further comprises at least a pair of hydraulic or other mechanical arms 111, a distal end of each arm 111 in turn comprising a cleaning unit 113 disposed thereon. Each cleaning unit 113 comprises the same components of the cleaning unit 13 disclosed above and seen in FIGS. 6-9 including a housing, a brush, a first proximity sensor 132, a second proximity sensor, and means for rotating or actuating the brush as disclosed above.

During use, the device 100 actuates each of the cleaning units 113 to clean each of the parallel wires 102 as the device 100 traverses along the length of the wires 102. Each of the first and second proximity sensors 132, 134 disposed on any of the plurality of cleaning units 113 determine not only the direction of motion of the command and control unit 104 on the wires 102, but also the presence of any obstructions on the wires 102 including but not limited to hot spots 158, spacers 159, or any other abnormality which may change the diameter of the wires 102. In one example, when the device 100 approaches a hot spot 158 disposed on the wires 102 as seen in FIG. 12, the first proximity sensor 132 disposed on a lead cleaning unit 113 detects the position of the hot spot 158 and notifies the command and control unit 104 of its presence. In some embodiments, an operational user may also be notified of the presence of the hot spot 158. The internal logic of the command and control unit 104 automatically follows a predetermined sequence of motions to traverse over the hot spot 158 without user interaction or intervention. For example, after coming to a stop using the brakes 56, the command and control unit 104 retracts the lead cleaning unit 113 off of the wire 102 which includes the hot spot 158 by actuating the corresponding hydraulic arm 111 in a direction so that the cleaning unit 113 is lifted up and off of the surface of the corresponding wire 102. The command and control unit 104 then actuates the motor to drive motion wheels 120a, 120b so that the command and control unit 104 moves forward towards the hot spot 158 with the lead cleaning unit 113 remaining in a raised or retracted position from the wire 102. As the first motion wheel 120b makes contact with the hot spot 158, the increased diameter of the hot spot 158 relative to the wire 102 is compensated by the support rod 135 moving upward which in turn further compresses the spring 141, thereby ensuring that both the motion wheel 120b and the support wheel 120c remain firmly engaged with hot spot 158 and the wire 102, respectively. After the retracted cleaning unit 113 has moved past the hot spot 158, the command and control unit 104 reengages the lead cleaning unit 113 by actuating the arm 111 so as to bring the cleaning unit 113 towards the wire 102, the brush 18 once again making contact with the wire 102. The second proximity sensor 134 disposed on the lead cleaning unit 113 ensures that the hot spot 158 is now in fact behind or downstream of the lead cleaning unit 113. The command and control unit 104 resumes its traversal down the wire 102 in the same original direction until the first proximity sensor 132 disposed on the remaining or rear cleaning unit 113 detects the hot spot 158. The command and control unit 104 then actuates the arm 111 coupled to the rear cleaning unit 113 which retracts or raises the rear cleaning unit 113 upwards and off of the surface of the wire 102. Next the command and control unit 104 once again moves forward with the support wheel 120c and the remaining motion wheel 120a compensating for the larger relative diameter of the hot spot 158 as the device 100 fully traverses over the length of the hot spot 158. After passing the hot spot 158, the command and control unit 104 actuates the arm 111, thereby bringing the rear cleaning unit 113 back into contact with the wire 102. The second proximity sensor 134 disposed on the cleaning unit 113 confirms the position of the rear cleaning unit 113 along the length of the wire 102 relative to the position of the hot spot 158. Once fully clear of the hot spot 158, the command and control unit 104 once again signals the motor 16 to drive the device 100 forward along the length of the wires 102 with each of the brushes 18 disposed within the corresponding cleaning units 113 brushing or scrubbing the wire 102 while the device 100 is in transit. It is in this manner that the device 100 can “walk” or “step over” the hot spot 158 or spacer 159 in its path so as to continue perform its principal task of cleaning the length of the wire 102.

Because each of the sub-units 106 are engaged on a corresponding one of the parallel wires 102 and each sub-unit 106 also comprises its own lead and rear cleaning units 113, the device 100 may traverse any obstacles in any sequence. For example, if a hot spot 158 is disposed on only one of the parallel wires 102, the device 100 may actuate the appropriate cleaning unit 113 as the hot spot 158 is detected, meaning that one of the sub-units 106 may be traversing over a hot spot 158 in the manner discussed above while the remaining sub-unit 106 remains firmly engaged with its corresponding wire 102. Relatedly, if an obstruction common to both parallel wires 102 is detected, such as a spacer 159 as seen in FIG. 12, the command and control unit 104 may command the lead cleaning unit 113 of each respective sub-unit 106 to be lifted simultaneously, thereby allowing the entirety of the device 100 to traverse over the spacer 159 all at once.

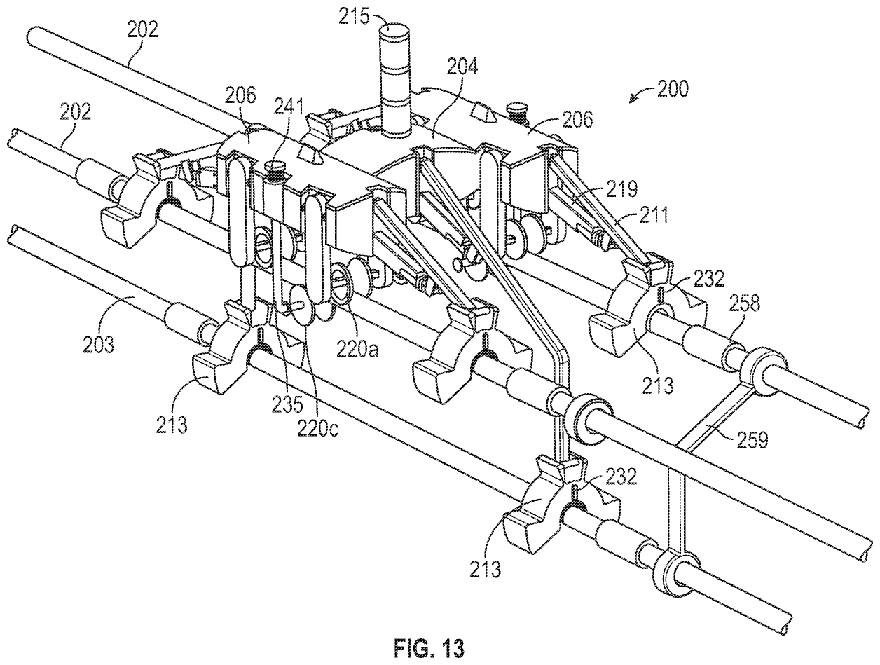

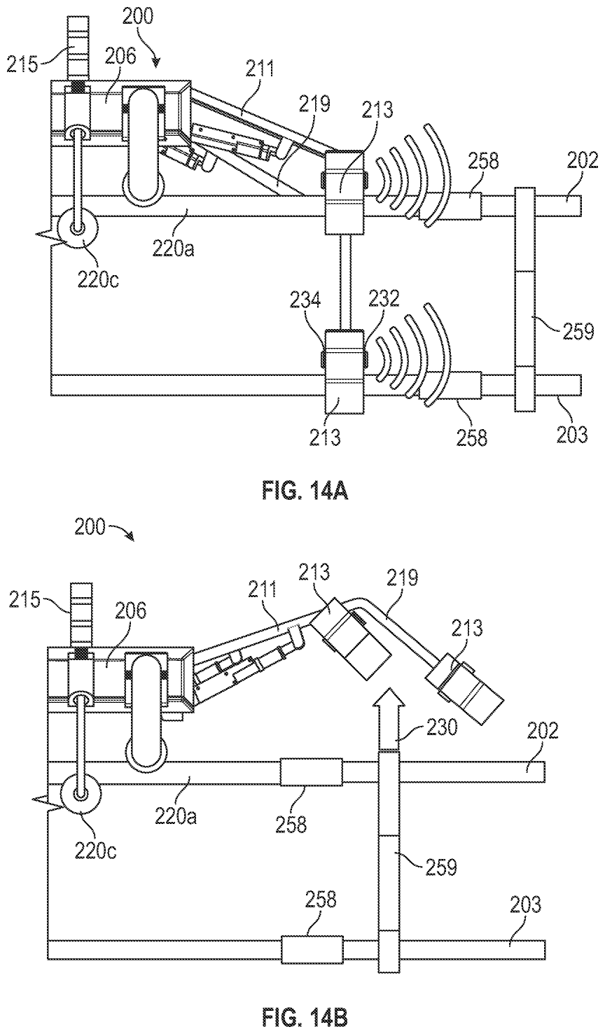

Another alternative embodiment of the power line cleaning device 200 may be seen in FIGS. 13-14B where the device 200 is specifically configured to engage, traverse, and clean a pair of upper parallel wires 202 and a single lower wire 203. In this embodiment, a command and control unit 204 of the device 200 extends between substantially similar sub-units 206, each one of the sub-units 206 being disposed on one of the pair of parallel wires 202. The command and control unit 204 further comprises at least a pair of extended retractable arms 219, for example at least one extended retractable arm 219 extending from either longitudinal end of the of the command and control unit 204. Each extended retractable arm 219 comprises a cleaning unit 213 disposed on its respective end and is configured to reach downward from the command and control unit 204, between the pair of upper parallel wires 202, and to the lower wire 203 where the brush 18 disposed within the cleaning unit 213 may make contact and engage therewith. The device 200 traverses the wires 202, 203 from a top portion or surface of the upper wires 202, namely with the command and control unit 204 and sub-units 206 being disposed above the upper wires 202 while the cleaning units 213 of each of the sub-units 206 and the extended retractable arms 219 extend downward from the device 200 to engage with the respective wires 202, 203. In some embodiments, a signal and warning light 215 is disposed on the command and control unit 204 and between the parallel upper wires 202.

Each of the sub-units 206 are substantially similar to the power line cleaning device 10 disclosed above, namely with each sub-unit 206 comprising a pair of motion wheels 220a, 220b which are driven by a motor (not seen) disposed within the sub-unit 206. Each sub-unit 206 also comprises a support wheel 220c coupled to the sub-unit 206 by a support rod 235 and a spring 241. Because each sub-unit 206 comprises its own support wheel 220c and support rod 235, each sub-unit 206 may independently and automatically adjust or compensate for a change in diameter of the upper wire 202 onto which the sub-unit 206 is currently disposed. Each sub-unit 206 further comprises at least a pair of hydraulic or other mechanical arms 211, a distal end of each arm 211 in turn comprising a cleaning unit 213 disposed thereon. Each cleaning unit 213 comprises the same components of the cleaning unit 13 disclosed above and seen in FIGS. 6-9 including a housing, a brush, a first proximity sensor 232, a second proximity sensor 234, and means for rotating or actuating the brush as disclosed above.

During use, the device 200 actuates each of the cleaning units 213 to clean each of the parallel upper wires 202 as the device 200 traverses along the length of the wires 202, 203. Each of the first and second proximity sensors 232, 234 disposed on any of the plurality of cleaning units 213 determine not only the direction of motion of the command and control unit 204 on the wires 202, 203, but also the presence of any obstructions on the wires 202, 203 including but not limited to hot spots 258, spacers 259, or any other abnormality which may change the diameter of the wires 202, 203. In one example, when the device 200 approaches a hot spot 258 disposed on the wires 202, 203 as seen in FIGS. 14A and 14B, the first proximity sensor 232 disposed on a lead cleaning unit 213 detects the position of the hot spot 258 and notifies the command and control unit 204 of its presence. In some embodiments, an operational user may also be notified of the presence of the hot spot 258, however in a preferred embodiment, the internal logic of the command and control unit 204 automatically follows a predetermined sequence of motions to traverse over the hot spot 258 without user interaction or intervention. For example, after coming to a stop using the brakes 56, the command and control unit 204 retracts the lead cleaning unit 213 off of each wire 202, 203 which includes the hot spot 258 by actuating the corresponding hydraulic arm 211 and extended retractable arm 219 in the direction indicated by arrow 230 so that the cleaning units 213 are lifted up and off of the surface of the corresponding wires 202, 203. The command and control unit 204 then actuates the motor 16 to drive motion wheels 220a, 220b so that the command and control unit 204 moves forward towards the hot spot 258 with the lead cleaning units 213 remaining in a raised or retracted position from the wires 202, 203. As the first motion wheel 220b makes contact with the hot spot 258, the increased diameter of the hot spot 258 relative to the wire 202, 203 is compensated by the support rod 235 moving upward which in turn further compresses the spring 241, thereby ensuring that both the motion wheel 220b and the support wheel 220c remain firmly engaged with hot spot 258 and the wire 202, 203, respectively. After the retracted cleaning units 213 have moved past the hot spot 258, the command and control unit 204 reengages the lead cleaning units 213 by actuating the arm 211 and the extended arm 219 so as to bring the cleaning units 213 back towards the wires 202, 203, the brush 18 once again making contact with the wires 202, 203. The second proximity sensor 234 disposed on the lead cleaning units 213 ensures that the hot spot 258 is now in fact behind or downstream of the lead cleaning unit 213. The command and control unit 204 resumes its traversal down the wires 202, 203 in the same original direction until the first proximity sensor 232 disposed on the remaining or rear cleaning units 213 detect the hot spot 258. The command and control unit 204 then actuates the arms 211, 219 coupled to the rear cleaning units 213 which retracts or raises the rear cleaning units 113 upwards and off of the surface of the wires 202, 203. Next the command and control unit 204 once again moves forward with the support wheel 220c and the remaining motion wheel 220a compensating for the larger relative diameter of the hot spot 258 as the device 200 fully traverses over the length of the hot spot 158. After passing the hot spot 258, the command and control unit 204 actuates the arms 211, 219, thereby bringing the rear the cleaning unit 213 back into contact with the wires 202, 203. The second proximity sensor 234 disposed on each cleaning unit 213 confirms the position of the rear cleaning unit 213 along the length of each respective wire 202, 203 relative to the position of the hot spot 258. Once fully clear of the hot spot 258, the command and control unit 204 once again signals the motor 16 to drive the device 200 forward along the length of the wires 202, 203 with each of the brushes 18 disposed within the corresponding cleaning units 213 brushing or scrubbing the wires 202, 203 while the device 200 is in transit. It is in this manner that the device 200 can “walk” or “step over” the hot spot 258 or spacer 259 in its path so as to continue perform its principal task of cleaning the length of the wires 202, 203.

Because each of the sub-units 206 are engaged on a corresponding one of the parallel upper wires 202 and each sub-unit 206 also comprises its own lead and rear cleaning units 213, while the command and control unit 204 further comprises its own lead and rear cleaning units 213 for cleaning the lower wire 203 via actuation of the extended retractable arms 219, the device 200 may traverse any obstacles disposed on any of the wires 202, 203 in any sequence. For example, if a hot spot 258 is disposed on only one of the parallel upper wires 202, the device 200 may actuate the appropriate arm 211 and cleaning unit 213 as the hot spot 258 is detected, meaning that one of the sub-units 206 may be traversing over a hot spot 258 in the manner discussed above while the remaining sub-unit 206 remains firmly engaged with its corresponding upper wire 202. Similarly, if a hot spot 258 is detected only on the lower wire 203, the device 200 may actuate the appropriate extended arm 219 and cleaning unit 213 as the hot spot 258 is detected, meaning that the cleaning units 213 disposed on both of the sub-units 206 remain firmly engaged with the upper wires 202 throughout the process as the hot spot 258 disposed on the lower wire 203 is traversed. If an obstruction common to both the parallel upper wires 202 and the lower wire 203 is detected, such as a spacer 259 as seen in FIGS. 13-14B, the command and control unit 204 may command the lead cleaning unit 213 of each respective sub-unit 206 and the lead cleaning unit 213 actuated by an extended arm 219 to be lifted simultaneously, thereby allowing the entirety of the device 200 to traverse over the spacer 259 all at once.

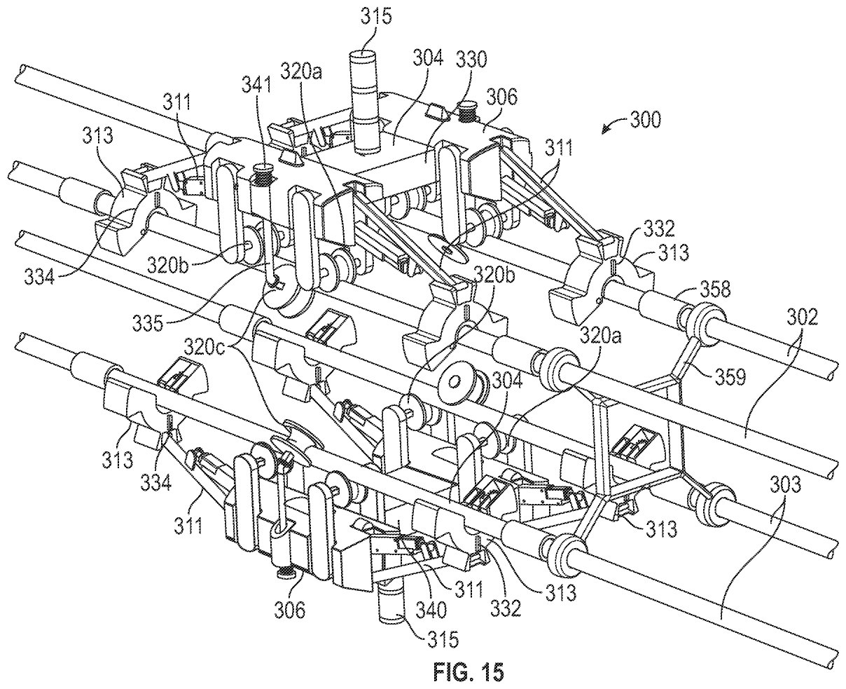

Another alternative embodiment of the power line cleaning device 300 may be seen in FIGS. 15-17 where the device 300 is specifically configured to engage, traverse, and clean two pairs of parallel wires, specifically a pair of upper parallel wires 302 and a pair of lower parallel wires 303. In this embodiment, the device 300 comprises a dual module system, namely with an upper module 330 configured to engage and traverse the upper parallel wires 302 while riding on or above the wires 302, and a lower module 340 configured to engage and traverse the lower parallel wires 303 while hanging below the lower wires 303 as seen in FIG. 15. Each of the modules 330, 340 comprises a command and control unit 304 which extends between substantially similar sub-units 306, each one of the sub-units 306 being disposed on one of the pair of parallel wires 302, 303. The upper module 330 traverses the upper wires 302 from a top portion or surface of the wires 302, namely with the command and control unit 304 and sub-units 306 being disposed above the wires 302 while the cleaning units 313 of each of the sub-units 306 extend downward from the upper module 330 to engage with the respective upper wires 302. Relatedly, the lower module 340 traverses the lower wires 303 from a bottom portion or surface of the wires 303, namely with the command and control unit 304 and sub-units 306 being disposed below the wires 303 while the cleaning units 313 of each of the sub-units 306 extend upward from the lower module 340 to engage with the respective lower wires 303. In some embodiments, a signal and warning light 15 is disposed on the command and control unit 304 and between the parallel upper wires 302 and the parallel lower wires 303. Both the upper module 330 and the lower module 340 are configured to communicate with each other and with an outside operator, specifically with each module 330, 340 comprising the ability to send and receive signals, data, commands, and/or instructions to each other and to the outside operator. As used herein, an outside operator may refer to any entity beyond the device 300 itself, for example the outside operator may be a technician or other specialist in front of a PC that is connected to the device 300 via the internet, or in certain embodiments the outside operator may be an instructional algorithm located on a server that is in communication with the device 300.

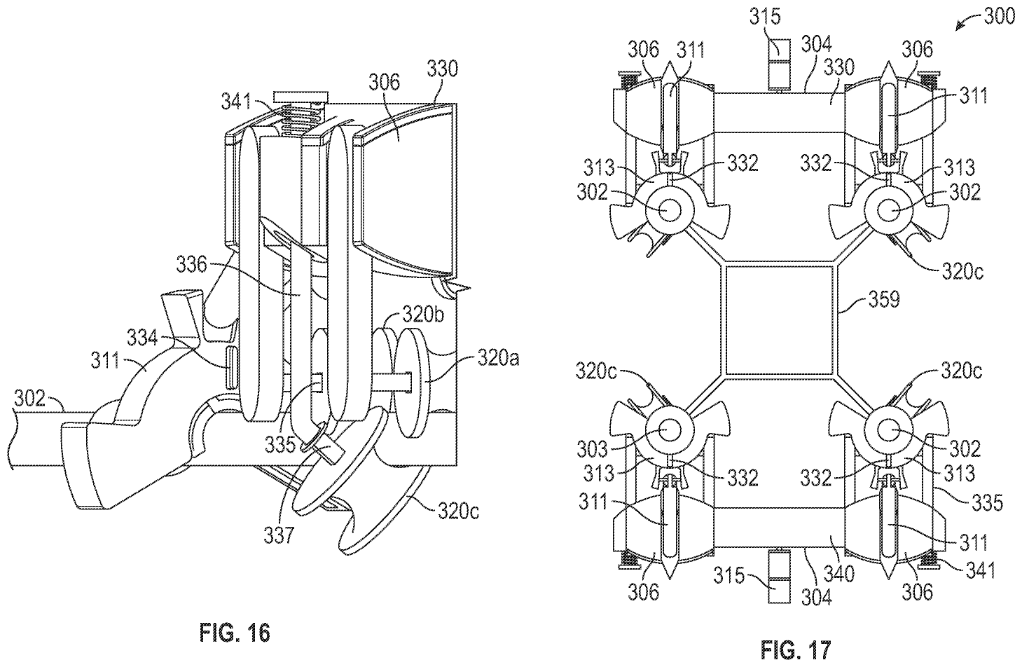

Each of the sub-units 306 are substantially similar to the power line cleaning device 10 disclosed above, namely with each sub-unit 306 comprising a pair of motion wheels 320a, 320b which are driven by a motor (not seen) disposed within each sub-unit 306. However as best seen in FIG. 16, each sub-unit 306 also comprises a support wheel 320c coupled to the sub-unit 306 by an extended support rod 335 and a spring 341. The extended support rod 335 comprises a substantially vertical portion 336 and an angled portion 337 disposed through the support wheel 320c. The angled portion 337 is configured to orientate or dispose the support wheel 320c at an angle with respect to the wire 302, 303 so that the support wheel 320c engages with the wire 302, 303 at a position that is radially offset with respect to the engagement of the motion wheels 320a, 320b. For example, as can be seen in FIG. 16, the motion wheels 320a, 320b of the upper module 330 are substantially vertically engaged with the wire 302 while the support wheel 320c is engaged with the same wire 302 at an angle that is offset from the vertical engagement of the motion wheels 320a, 320b. Having the support wheel 320c engaged with a corresponding wire 302, 303 at an offset angle permits the support wheel 320c to pass over obstructions such as the spacer 359 seen in FIGS. 15 and 17 and discussed in further detail below without interfering or making unwanted contact with the obstruction itself. Additionally, because each sub-unit 306 comprises its own support wheel 320c and support rod 335, each sub-unit 306 may independently and automatically adjust or compensate for a change in diameter of the wire 302, 303 onto which the sub-unit 306 is currently disposed. Each sub-unit 306 further comprises at least a pair of hydraulic or other mechanical arms 311, a distal end of each arm 311 in turn comprising a cleaning unit 313 disposed thereon. Each cleaning unit 313 comprises the same components of the cleaning unit 13 disclosed above and seen in FIGS. 6-9 including a housing, a brush, a first proximity sensor 332, a second proximity sensor 334, and means for rotating or actuating the brush as disclosed above.

During use, the device 300 actuates each of the cleaning units 313 disposed on the upper module 330 and the lower module 340 to clean each of the parallel upper wires 302 and lower wires 303 as the modules 330, 340 traverse along the length of the wires 302, 303. Each of the first and second proximity sensors 332, 334 disposed on any of the plurality of cleaning units 313 determine not only the direction of motion of the command and control unit 304 of the corresponding module 330, 340 on the wires 302, 303 but also the presence of any obstructions on the wires 302 including but not limited to hot spots 358, spacers 359, or any other abnormality which may change the diameter of the wires 302, 303. In one example, when the device 300 approaches a hot spot 358 disposed on the wires 302, 303 as seen in FIG. 15, the first proximity sensor 332 disposed on a lead cleaning unit 313 detects the position of the hot spot 358 and notifies its corresponding command and control unit 304 of its presence. In some embodiments, an operational user may also be notified of the presence of the hot spot 358, however in a preferred embodiment, the internal logic of the command and control unit 304 automatically follows a predetermined sequence of motions to traverse over the hot spot 358 without user interaction or intervention. For example, after coming to a stop using the brakes 56, the command and control unit 304 retracts the lead cleaning unit 313 off of the wire 302 which includes the hot spot 358 by actuating the corresponding hydraulic arm 311 in a direction so that the cleaning unit 313 is lifted up and off of the surface of the corresponding wire 302. The command and control unit 304 then actuates the motor 16 to drive motion wheels 320a, 320b so that the command and control unit 304 moves forward towards the hot spot 358 with the lead cleaning unit 313 remaining in a raised or retracted position from the wire 302. As the first motion wheel 320b makes contact with the hot spot 358, the increased diameter of the hot spot 358 relative to the wire 302 is compensated by the support rod 335 moving upward which in turn further compresses the spring 341, thereby ensuring that both the motion wheel 320b and the support wheel 320c remain firmly engaged with hot spot 358 and the wire 302, respectively. After the retracted cleaning unit 313 has moved past the hot spot 358, the command and control unit 304 reengages the lead cleaning unit 313 by actuating the arm 311 so as to bring the cleaning unit 313 back down towards the wire 302, the brush 18 once again making contact with the wire 302. The second proximity sensor 334 disposed on the lead cleaning unit 313 ensures that the hot spot 358 is now in fact behind or downstream of the lead cleaning unit 313. The command and control unit 304 resumes its traversal down the wire 302 in the same original direction until the first proximity sensor 332 disposed on the remaining or rear cleaning unit 313 detects the hot spot 358. The command and control unit 304 then actuates the arm 311 coupled to the rear cleaning unit 313 which retracts or raises the rear cleaning unit 313 upwards and off of the surface of the wire 302. Next the command and control unit 304 once again moves forward with the support wheel 320c and the remaining motion wheel 320a compensating for the larger relative diameter of the hot spot 358 as the device 300 fully traverses over the length of the hot spot 358. After passing the hot spot 358, the command and control unit 304 actuates the arm 311, thereby bringing the rear cleaning unit 313 back into contact with the wire 302. The second proximity sensor 334 disposed on the cleaning unit 313 confirms the position of the rear cleaning unit 313 along the length of the wire 302 relative to the position of the hot spot 358. Once fully clear of the hot spot 358, the command and control unit 304 once again signals the motor 16 to drive the device 300 forward along the length of the wires 302 with each of the brushes 18 disposed within the corresponding cleaning units 313 brushing or scrubbing the wire 302 while the device 300 is in transit. It is in this manner that the device 300 can “walk” or “step over” the hot spot 358 or spacer 359 in its path so as to continue perform its principal task of cleaning the length of the wire 302.

Because each of the sub-units 306 of each of the modules 330, 340 are engaged on a corresponding one of either the parallel upper wires 302 or the parallel lower wires 303, and each sub-unit 306 also comprises its own lead and rear cleaning units 313, the device 300 may traverse any obstacles in any sequence. For example, if a hot spot 358 is disposed on only one of the parallel upper wires 302, the device 300 may actuate the appropriate cleaning unit 313 as the hot spot 358 is detected, meaning that one of the sub-units 306 of the upper module 330 may be traversing over a hot spot 358 in the manner discussed above while the remaining sub-unit 306 of the upper module 330 remains firmly engaged with its corresponding upper wire 302.

Furthermore, while the upper module 330 and the lower module 340 are not physically coupled together, in certain embodiments the upper module 330 and lower module 340 are in constant communication with each other via their respective communications antennas 17 and communications subsystems so that if an obstruction common to both the parallel upper wires 302 and the parallel lower wires 303 is detected, such as a spacer 359 as seen in FIGS. 15 and 17, the command and control unit 304 of both the upper module 330 and the lower module 340 may instruct the lead cleaning unit 313 of each of their respective sub-units 306 to be lifted simultaneously or in sequence as needed, thereby allowing the entirety of the device 300 to traverse over the spacer 359 all at once, namely with the upper module 330 passing over the top portion of the spacer 359 while the lower module 340 passes under the bottom portion of the spacer 359. Alternatively, in certain other embodiments, the upper module 330 may proceed to traverse over an obstruction while the lower module 340 remains stationary, and then after the upper module 330 has successfully completed its traversal, may then in turn remain in a stationary position until the lower module 340 has successfully completed its own traversal of the obstruction. In other words, the upper module 330 and the lower module 340 may operate in tandem, in unison, or any variation thereof as conditions dictate.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. An apparatus for autonomous cleaning of an electrical wire comprising:
a command and control unit;
a plurality of retractable arms coupled to the command and control unit;
a cleaning unit disposed on a distal end of each of the plurality of retractable arms;
at least one motion wheel coupled to a motor disposed in the command and control unit, the at least one motion wheel in continuous contact with the electrical wire; and
a support wheel coupled to the command and control unit, the support wheel in continuous contact with the electrical wire and configured to compensate for changes in a diameter of the electrical wire.

2. The apparatus of the claim 1 wherein each of the cleaning units comprises:
a housing;
a plurality of proximity sensors disposed on an outside surface of the housing;
at least one rotating brush configured to clean the electrical wire disposed within an internal cavity of the housing; and
at least one brush motor disposed within the housing and coupled to the at least one brush,
wherein the housing comprises a hollow center configured to accommodate the electrical wire therein.

3. The apparatus of claim 2 wherein the command and control unit comprises a control circuit for controlling the operation of the motor disposed in the command and control unit, the plurality of retractable arms, and the at least one brush motor.

4. The apparatus of claim 2 wherein at least one of the plurality of proximity sensors disposed on an outside surface of the housing is configured to detect an obstruction disposed on the electrical wire.

5. The apparatus of claim 2 wherein at least one of the plurality of proximity sensors disposed on an outside surface of the housing is configured to detect a change in diameter of the electrical wire.

6. The apparatus of claim 1 wherein each of the plurality of retractable arms are configured to selectively remove the cleaning unit from a surface of the electrical wire.

7. The apparatus of claim 1 further comprising a plurality of signal and warning lights removably coupled to the command and control unit.

8. The apparatus of claim 1 wherein the support wheel is coupled to a support rod disposed through a spring housing disposed on the command and control unit, and wherein a spring is disposed between an end portion of the support rod and the spring housing.

9. The apparatus of claim 1 wherein the command and control unit comprises a plurality of sub units, each of the plurality of sub units comprising at least one of the plurality of retractable arms.

10. The apparatus of claim 1 further comprising at least one extended retractable arm coupled to the command and control unit, wherein the at least one extended retractable arm comprises a cleaning unit disposed on a distal end of the at least one extended retractable arm.

11. A system for autonomous cleaning of a plurality of electrical wires comprising:
a first module; and
a second module in communication with the first module;
wherein the first module and the second module each comprise:
a command and control unit;
a plurality of sub units disposed on the command and control unit;
a plurality of retractable arms coupled to each of the plurality of sub units;
a cleaning unit disposed on a distal end of each of the plurality of retractable arms;
at least one motion wheel coupled to a motor disposed in each of the sub units, the at least one motion wheel in continuous contact with one of the plurality of electrical wires; and
a support wheel coupled to each of the plurality of sub units, the support wheel in continuous contact with one of the electrical wire and configured to compensate for changes in a diameter of the electrical wire.

12. The system of claim 11 wherein the support wheel coupled to the command and control unit is coupled to a support rod disposed through a spring housing disposed on the command and control unit, wherein the support rod is configured to maintain the support wheel at an angle relative to the at least one motion wheel.

13. The system of claim 11 wherein either the first module or the second module is configured to engage a length of at least two of the plurality electrical wires from a position above the at least two of the plurality of electrical wires,
wherein the remaining one of the first module or the second module is configured to engage a length of at least two of the plurality electrical wires from a position below the at least two of the plurality of electrical wires.

14. The system of claim 11 wherein the first module and the second module are each configured to transmit and receive signals, data, commands, or instructions to each other and to an outsider operator.

15. A method for autonomously cleaning an electrical wire comprising:
engaging the electrical wire between a support wheel and at least one motion wheel of a cleaning device;
brushing a surface of the electrical wire with a first cleaning unit disposed on a distal end of a first retractable arm disposed on the cleaning device;
detecting an obstruction on the electrical wire by the first cleaning unit;
retracting the first cleaning unit off of the electrical wire;
traversing the cleaning device over the obstruction detected on the electrical wire;
reengaging the first cleaning unit with the electrical wire; and
resuming brushing of the surface of the electrical wire with the first cleaning unit.

16. The method of claim 15 further comprising:
detecting the obstruction on the electrical wire by a second cleaning unit disposed on a distal end of a second retractable arm disposed on the cleaning device after the cleaning device has traversed over the obstruction on the electrical wire;
retracting the second cleaning unit off of the electrical wire;
traversing the cleaning device down a length of the electrical wire;
reengaging the second cleaning unit with the electrical wire; and
resuming brushing of the surface of the electrical wire with the second cleaning unit.

17. The method of claim 15 where engaging the electrical wire between the support wheel and the at least one motion wheel of the cleaning device comprises the support wheel automatically compensating for a change in diameter of the electrical wire.

18. The method of claim 15 further comprising the cleaning device transmitting a data signal related to at least one of an elapsed operation time, a distance traveled by the cleaning device, or a number or type of obstructions detected by the cleaning device to a remote location.

19. The method of claim 15 further comprising performing data collection, operational monitoring, performing remote control of the first cleaning unit, performing data wireless communication, or visually inspecting the electrical wire with at least one camera to provide real time or recorded visual inspection of the electrical wire and cleaning of the electrical wire.

20. A method for autonomously cleaning a plurality of electrical wires comprising:
engaging a first parallel pair of the plurality of electrical wires with a first cleaning device;
engaging a second parallel pair of the plurality of electrical wires with a second cleaning device;
transmitting a plurality of data and command signals between the first cleaning device and the second cleaning device;
brushing a surface of the first parallel pair of the plurality of electrical wires with a first plurality of cleaning units disposed on a respective distal end of a first plurality of retractable arms disposed on the first cleaning device; and
brushing a surface of the second parallel pair of the plurality of electrical wires with a second plurality of cleaning units disposed on a respective distal end of a second plurality of retractable arms disposed on the second cleaning device,
wherein engaging the first parallel pair of the plurality of electrical wires with the first cleaning device comprises engaging the first pair of parallel electrical wires from a position above the first pair of parallel electrical wires, and
wherein engaging the second parallel pair of the plurality of electrical wires with the second cleaning device comprises engaging the second pair of parallel electrical wires from a position below the second pair of parallel electrical wires.
